(19) United States
(12) Patent Application Publication
(10) Pub. No.: US 2003/0007072 A1
(43) Pub. Date: Jan. 9, 2003

(54) Method and device for detecting seat occupancy by means of a video sensor system and foot room system

(76) Inventors: Bernhard Mattes, Sachsenheim (DE); Hans-Peter Lang, Ludwigsburg (DE); Pascal Kocher, Gerlingen (DE)

Correspondence Address: KENYON & KENYON, ONE BROADWAY, NEW YORK, NY, 10004, US

(21) Appl. No.: 09/959,050

(22) PCT Filed: Feb. 9, 2001
(86) PCT No.: PCT/DE01/00500

(30) Foreign Application Priority Data
Feb. 16, 2000 (DE) 100 07 014.0

(51) Int. Cl. H04N 7/18

(52) U.S. Cl. 348/77; 348/61

(57) ABSTRACT

In order to clearly distinguish between a short adult and a child sitting in a booster seat, for example, on the passenger seat of a vehicle, a video sensor system (4) detects the head height of the person sitting in the passenger seat (1). A footwell sensor (5, 6) recognizes whether a person is touching the floor in front of the passenger seat (1) with one foot or both feet. An analyzer unit (7) classifies the person sitting in the passenger seat (1) as a child for whom it causes a passenger air bag (3) present to be deactivated if the video sensor system (4) registers a head height that is less than a predefined threshold (SH) and, at the same time, the footwell sensor (5,6) detects no foot contact with the floor in front of the passenger seat (1).

### BACKGROUND INFORMATION

The present invention relates to a method and a device for seat occupancy recognition, a video sensor system detecting the head height of a person sitting on the passenger seat of a vehicle.

According to the teaching of U.S. Pat. No. 5,983,147, for example, the scene of the passenger seat is recorded using a video sensor, preferably a stereo camera, and, by evaluating the recorded scene, it is determined whether the passenger seat is occupied at all, whether it is occupied by an adult, a child, or an object. Research, for example, by NHTSA (National Highway Traffic Safety Administration) in the U.S. has shown that children sitting on a vehicle's passenger seat have suffered fatal injuries by the deployment of the passenger air bag. Risk of injury for a person on the passenger seat due to a deploying air bag exists if the distance between the person and the air bag becomes too small due to the person's sitting position, body size, or due to his or her leaning forward toward the passenger air bag immediately prior to the occurrence of the accident. There are passenger seat occupancy situations in which the passenger air bag should not be deployed at all in a crash. These occupancy situations include, for example, occupancy by an object that need not be protected and an excessively small distance between a passenger and the passenger air bag, but particularly when a child is sitting on the passenger seat. The video sensor system described in U.S. Pat. No. 5,983,147 detects the type of occupancy of the passenger seat, i.e., whether it is occupied by an object, an adult, or a child in a child seat facing backward. The known video sensor system can also determine the head height of the person (adult or child).

The passenger air bag should not only be deactivated in the case of small children sitting in a child seat facing backward, but also in the case of somewhat older children (5 to 8 years old), who, as a rule, sit in a booster seat placed on the passenger seat. With the booster seat, 5 to 8 year old children reach a head height corresponding to that of a relatively short adult. Therefore, the video sensor system was unable to make a distinction between a child sitting in a booster seat, for whom the passenger air bag should be deactivated, and an adult with the same head height, for whom the passenger air bag must remain activated. The NHTSA requires that a seat occupancy recognition system make a distinction between a “5% woman” and a child (approximately 5 to 8 years old) sitting in a booster seat, since the passenger air bag should remain activated for a “5% woman” and should be deactivated for a child on a booster seat. “5% woman” is defined as a woman no more than 1.50 m tall and a body weight of no more than 50 kg. These women represent approximately 5% of the overall female population.

If a weight sensor is available with the seat occupancy recognition system, it is still incapable of making a distinction between the two individuals, “5% woman” and a child in a booster seat, since they are both in the same weight category.

The object of the present invention is therefore to provide a method and a device of the above-mentioned type that allows a distinction to be made, with the highest possible reliability, between an adult having a small body size (deployment) and a child in a booster seat (non-deployment).

### ADVANTAGES OF THE PRESENT INVENTION

The aforementioned object is achieved with the features of claims 1 and 2 by the fact that, in addition to a video sensor system, which detects the head height of a person sitting in the passenger seat of a vehicle, there is a footwell sensor which determines whether a person is touching the floor in front of the passenger seat with one foot or both feet. Then the person sitting in the passenger seat is classified as a child for whom the passenger air bag is to be deactivated if the video sensor system records a head height that is less than a predefined threshold and, at the same time, the footwell sensor detects no foot contact with the floor in front of the passenger seat. Specifically, if the video sensor system detects a head height corresponding to that of a child sitting in a booster seat, a distinction can be unambiguously made using the footwell sensor whether this is actually a child in a booster seat or maybe a short adult, as the adult will always touch the floor in front of the passenger seat with one foot or both feet, while the child sitting in a booster seat does not reach the floor with its feet. The two sensors thus allow an unambiguous distinction to be made between a case of deployment “short adult” and non-deployment “child in booster seat.”

Advantageous refinements of the present invention are presented in the subclaims, according to which the footwell sensor is advantageously a pressure sensor which detects the pressure exerted on the floor in front of the passenger seat. The footwell sensor is preferably a pressure sensor which detects the profile of the object exerting the pressure when a pressure is exerted on the floor in front of the passenger seat. Pressure profiles can advantageously be detected by the fact that the footwell sensor has a plurality of individual pressure sensing elements.

### DRAWING

The present invention is elucidated in detail below with reference to an embodiment depicted in the drawing.

FIG. 1 schematically shows a passenger seat in a vehicle having a video sensor system and a footwell sensor.

FIG. 2 shows a flow chart for a seat occupancy recognition system.

### DETAILED DESCRIPTION OF AN EMBODIMENT

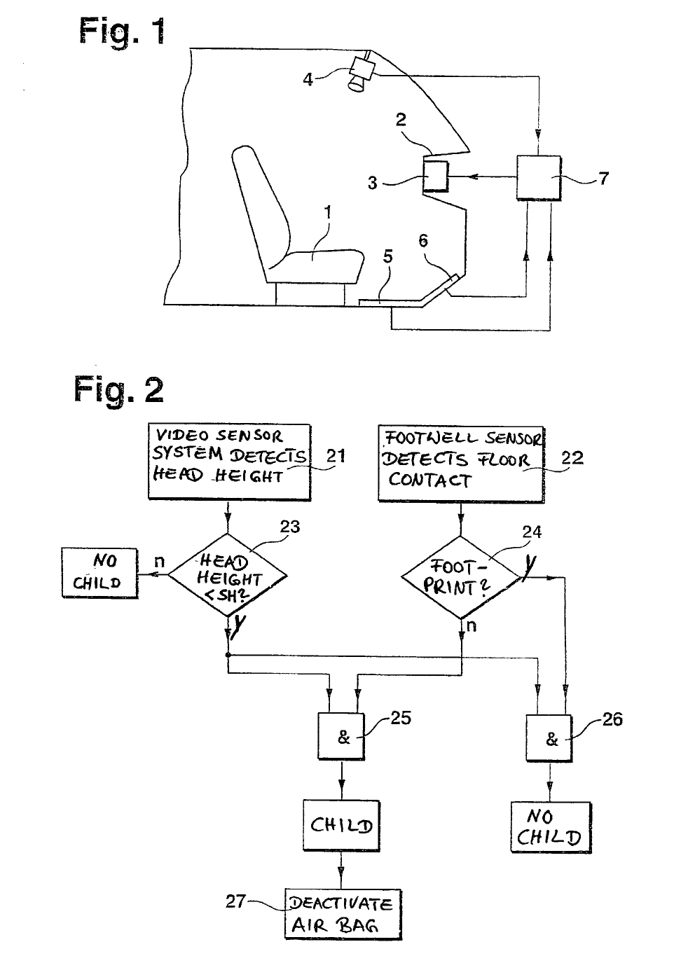

FIG. 1 shows a section of the passenger compartment of a vehicle having a passenger seat 1 in front of a dashboard 2, in which a passenger air bag 3 is installed. A video sensor system 4, which records the scene on and around passenger seat 1, is preferably arranged in the ceiling of the vehicle. Video sensor system 4 can be a video camera using CCD or CMOS technology in a known manner. It can be a mono or a stereo camera, a stereo camera being capable of recording a three-dimensional image, making it possible to better distinguish between different types of occupancy of the passenger seat. The operation of video sensor system 4 and the associated image signal processing will not be described in detail here since these are related art (see, for example, U.S. Pat. No. 5,983,147). Video sensor system 4 is capable of determining whether the passenger seat is occupied at all, whether an object is on the passenger seat, or whether a person is sitting there, or a child seat facing backward is installed on the passenger seat. Furthermore, video sensor system 4 can detect the head height of a person sitting on the passenger seat.

Video sensor system 4 cannot make a distinction between a short adult and a 5 to 8 year old child sitting in a booster seat placed on the passenger seat, because the booster seat provides the child with a head height that approximately corresponds to that of a short adult. Since the passenger air bag should remain activated for an adult sitting in the passenger seat, but it must be deactivated for a child in the passenger seat, video sensor system 4 is insufficient to make an unambiguous decision between activation and deactivation of the passenger air bag.

In order to arrive at an unambiguous decision even in the above-mentioned case, a footwell sensor 5, 6 is arranged in the footwell in front of passenger seat 1. In the illustrated embodiment, the footwell sensor has two parts. One part 5 is arranged on the horizontal floor area, and the other part 6 on the inclined floor area. In general, however, it is sufficient to provide a footwell sensor 5 only on the horizontal floor area. Footwell sensor 5, 6 records whether or not one foot or both feet of a person sitting in passenger seat 1 are touching the floor. A pressure sensor detecting the pressure exerted on the floor in front of passenger seat 1 is suitable as a footwell sensor.

In order to determine whether the pressure is exerted by the feet of a person or by some other object placed in the footwell in front of the passenger seat, the pressure sensor should be able to recognize the pressure profile. A pressure profile can be recorded by a footwell sensor formed from a plurality of pressure sensing elements. Different pressure sensor principles are known, such as, for example, pressure sensor mats integrated in the vehicle seats. There are pressure sensors having resistor elements with a pressure-dependent resistance or having elements whose capacitance changes as a function of the exerted pressure. There are also pressure sensors based on the microbending effect, in which case glass fibers are applied to an undulated substrate. The light flux through these glass fibers changes if the glass fibers are bent in a different way due to a pressure exerted on them.

The sensor signals are sent from footwell sensor 5, 6 and video sensor system 4 to an analyzer unit 7. Finally, analyzer unit 7 controls the activation or deactivation of passenger air bag 3 as a function of the sensor signals.

The flow chart shown in FIG. 2 explains how, with the help of video sensor system 4 and footwell sensor 5, 6 it can be unambiguously decided whether or not a child is sitting in the passenger seat, for whom the passenger air bag should be deactivated. In procedure steps 21 and 22, video sensor system 4 detects the head height of a person sitting in the passenger seat, and footwell sensor 5, 6 detects whether there is contact with the floor in front of the passenger seat. A threshold value decision takes place in procedure step 23: the head height of the person detected by the video sensor system is compared with a threshold SH. If the head height is not less than a threshold SH, the analyzer unit can decide with certainty that no child is sitting in passenger seat 1. Threshold SH is therefore selected so that children for whom the passenger air bag must definitely be deactivated, even when they are sitting in a booster seat, do not exceed this heat height SH. In procedure step 24, the information of the footwell sensor is analyzed and it is determined whether there is a footprint on the floor in front of passenger seat 1.

Procedure step 25 checks whether the first condition that the detected head height is less than the predefined threshold SH and the second condition that there is no footprint on the floor in front of the passenger seat are met simultaneously. If both conditions are met, analyzer unit 7 decides that a child is sitting in passenger seat 1, since a child sitting in the passenger seat, especially if it also sitting in a booster seat, does not reach the floor in front of passenger seat 1 with its feet. However, the child may occasionally reach the head height of a short adult, especially if it is sitting in a booster seat. However, an adult will usually touch the floor in front of the passenger seat with at least one foot, even if he or she has a head height that is less than threshold SH. Thus, in procedure step 26 it is determined whether the person sitting in the passenger seat simultaneously meets the first condition that a head height is less than a predefined threshold SH and the second condition that there is a footprint on the floor in front of the passenger seat. If both conditions are met, analyzer unit 7 decides that no child is sitting in passenger seat 1. In the case where a child is recognized in passenger seat 1, analyzer unit 7 issues a control signal in procedure step 27, deactivating passenger air bag 3.

What is claimed is:

1. A method of seat occupancy recognition using a video sensor system (4), which detects the head height of a person sitting in the passenger seat (1) of a vehicle,
wherein a footwell sensor (5, 6) detects whether a person is touching the floor in front of the passenger seat (1) with one foot or both feet; and the person sitting in the passenger seat (1) is classified as a child for whom the passenger air bag (3) is to be deactivated if the video sensor system (4) registers a head height that is less than a predefined threshold (SH) and, at the same time, the footwell sensor (5, 6) detects no foot contact with the floor in front of the passenger seat (1).

2. A device for seat occupancy recognition, having a video sensor system (4), which detects the head height of a person sitting in the passenger seat (1) of a vehicle,
wherein a footwell sensor (5, 6) is provided, which detects whether a person is touching the floor in front of the passenger seat (1) with one foot or both feet; and an analyzer unit (7) classifies a person sitting in the passenger seat (1) as a child for whom it causes a passenger air bag (3) present to be deactivated if the video sensor system (4) registers a head height that is less than a predefined threshold (SH) and, at the same time, the footwell sensor (5, 6) detects no foot contact with the floor in front of the passenger seat (1).

3. The device according to claim 2,
wherein the footwell sensor (5, 6) is a pressure sensor which detects the pressure exerted on the floor in front of the passenger seat.

4. The device according to claim 2,
wherein the footwell sensor (5, 6) is a pressure sensor which detects the profile of the object exerting the pressure when a pressure is exerted on the floor in front of the passenger seat (1).

5. The device according to claim 4,
wherein the footwell sensor (5, 6) has a plurality of pressure sensing elements.
